(19) United States
(12) Patent Application Publication
(10) Pub. No.: US 2025/0308131 A1
(43) Pub. Date: Oct. 2, 2025

(54) TILE-BASED IMMEDIATE MODE RENDERER GRAPHICS PIPELINE

(71) Applicant: ADVANCED MICRO DEVICES, INC., Santa Clara, CA (US)

(72) Inventors: Christopher J. Brennan, Boxborough, MA (US); Nishank Pathak, Orlando, FL (US)

(21) Appl. No.: 18/621,722

(22) Filed: Mar. 29, 2024

(51) Int. Cl. G06T 15/00; G06T 15/40; G06T 15/50

(52) U.S. Cl. CPC G06T 15/005; G06T 15/405; G06T 15/50

(57) ABSTRACT

To implement a tile-based immediate mode renderer graphics pipeline, an acceleration unit (AU) partitions a frame to be rendered into two or more tiles. For each primitive of a batch of primitives, the AU then determines whether the primitive is at least partially visible in a tile. Based on a primitive being at least partially visible in a tile, the AU stores geometry data of the primitive in the tile in a corresponding per-tile queue allocated to the tile. For each tile and using the geometry data in the per-tile queue allocated to the tile, the AU renders attribute data of the primitives at least partially visible in the tile to one or more buffers. The AU next determines lighting data for the primitives at least partially visible in the tile based on the attribute data in the buffer and stores the results in a frame buffer for display.

### BACKGROUND

In a graphics processing system, three-dimensional scenes are rendered by graphics processing units (GPUs) for display on two-dimensional displays. To render such scenes, a GPU receives a command stream from an application indicating various primitives to be rendered. The GPU then renders these primitives according to a graphics pipeline that has various stages each including instructions to be performed by the GPU. For example, some graphics pipelines include a visibility pass wherein the GPU sorts each primitive to be rendered into a bin based on which tile of the scene the primitive is visible in. The GPU then renders the primitives in each bin sequentially. For example, the GPU renders the primitives in a first bin before rendering the primitives in a second bin. After rendering the primitives, the graphics processing system displays the rendered primitives as part of a three-dimensional scene displayed in a two-dimensional display.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to implement a tile-based immediate mode renderer graphics pipeline, in accordance with some embodiments.

FIG. 2 is a block diagram of an example processor core configured to implement at least a portion of a tile-based immediate mode renderer graphics pipeline, in accordance with embodiments.

FIG. 3 is a timeline of an example tile-based immediate mode renderer graphics pipeline, in accordance with embodiments.

FIG. 4 is a block diagram of an example operation for managing geometry and pixel states for a tile-based immediate-render graphics pipeline, in accordance with embodiments.

FIG. 5 is an example method for implementing a tile-based immediate mode renderer graphics pipeline, in accordance with embodiments.

### DETAILED DESCRIPTION

Systems and techniques disclosed herein are directed towards a processing system configured to implement a tile-based immediate mode renderer graphics pipeline. Such a tile-based immediate mode renderer graphics pipeline is a graphics pipeline that includes first partitioning a frame to be rendered into two or more tiles. Further, the tile-based immediate mode renderer graphics pipeline includes determining which primitives of the frame to be rendered are at least partially visible in each tile and then sequentially rendering the primitives at least partially visible in each tile. For example, for a first tile of the frame, the tiled-based immediate-rendering graphics pipeline includes rendering, to one or more per-pixel color buffers (PPC buffers), pixel attribute data (e.g., locations, colors) associated with the primitives at least partially visible in the first tile. The tile-based immediate mode renderer graphics pipeline then includes determining, based on the pixel attribute data in the PPC buffers, lighting values (e.g., intensity values) for the pixels of the primitives at least partially visible in the first tile. The resulting pixel data and lighting data are then stored in a frame buffer and this process is repeated for each tile of the frame.

To implement such a tile-based immediate mode renderer graphics pipeline, a processing system includes an acceleration unit (AU) configured to receive a command stream from an application being executed by the processing system. The command stream, for example, includes data indicating the primitives to be rendered for each frame of a series of frames. As an example, for a first frame of a set of frames, the command stream includes data including one or more commands (e.g., draw commands, shading commands), geometry states, one or more pixel states, and data (e.g., vertices) indicating one or more primitives to be rendered in the frame. These geometry states include data (e.g. parameters) to initialize and dictate the tile-based immediate mode renderer graphics pipeline, geometry stages of the tile-based immediate mode renderer graphics pipeline, or both. Additionally, the pixel states include data (e.g., parameters) to initialize and dictate tile draw stages and tile lighting stages of the tile-based immediate mode renderer graphics pipeline. Such stages (e.g., geometry stages, tile draw stages, tile lighting stages) of the tile-based immediate mode renderer graphics pipeline each include sets of commands (e.g., draw commands, shading commands), geometry states, pixel states, or any combination thereof indicated in the command stream that use the same resources (e.g., same primitive data). Based on receiving the command stream, the AU first partitions the frame to be rendered into two or more tiles. Further, the AU allocates a corresponding per-tile queue to each tile of the frame. The AU then performs a geometry stage of the pipeline. During such a geometry stage, the AU determines which primitives of the frame are at least partially visible in each tile of the frame. Based on a primitive being at least partially visible in a tile, the AU stores geometry data indicating vertex data, shading data, positioning data, or any combination thereof of the primitive in the per-tile queue allocated to the tile.

After the AU has stored data indicating which primitives of a batch of primitives are at least partially visible in each tile of the frame, the AU, for example, initiates a tile draw stage of the tile-based immediate mode renderer graphics pipeline for a first tile. During the tile draw stage for the first tile, the AU renders the primitives at least partially visible in the first tile into one or more per-pixel color buffers (PPC buffers) based on the geometry data stored in the per-tile queue allocated to the first tile. That is to say, based on the geometry data stored in the per-tile queue allocated to the first tile, the AU determines pixel attribute data indicating the position and color of the pixels of the primitives of a batch of primitives at least partially visible in the first tile. After such pixel attribute data associated with the first tile is written to the PPC buffers, the AU performs a tile lighting stage of the tile-based immediate mode renderer graphics pipeline for the first tile. During the tile lighting stage for the first tile, the AU is configured to, based on the pixel attribute data associated with the first tile in the PPC buffers, determine lighting data (e.g., intensity data) for each pixel of the primitives at least partially visible in the first tile. The AU then stores, based on the lighting data for each pixel, data representing the color for each pixel of the primitives at least partially visible in the first tile to a frame buffer for display. The AU then performs tile draw stages and tile lighting stages for the remaining tiles of the frame.

In this way, the processing system implements the tile-based immediate mode renderer graphics pipeline. Because, within the tile-based immediate mode renderer graphics pipeline, the AU renders primitives based on a single command stream from an application, the processing system is not required to manage in-memory state objects to allow access to stored states by, for example, the AU. As such, the complexity and resources required to render the primitives are reduced, helping to improve processing efficiency. Additionally, because the AU determines lighting data for pixels from the pixel attribute data in the PPC buffers, the AU is not required to repeat the assembly and shading of primitives during the tile lighting stages, helping to reduce the processing resources and processing time needed to render the primitives. Further, in some instances, once the AU has completed a tile draw stage of the graphics pipeline for a first tile, the AU is configured to release the pixel attribute data associated with that first tile from the PPC buffers. As the pixel attribute data associated with that first tile is released from the PPC buffers, the AU is configured to, based on a corresponding pixel state of the command stream, perform a tile draw stage for a second tile of the frame. In this way, AU is not required to wait until the pixel attribute data is released before performing a next stage of the tile-based immediate mode renderer graphics pipeline, reducing the amount of time needed to perform the stages (e.g., groups of commands) of the tile-based immediate mode renderer graphics pipeline.

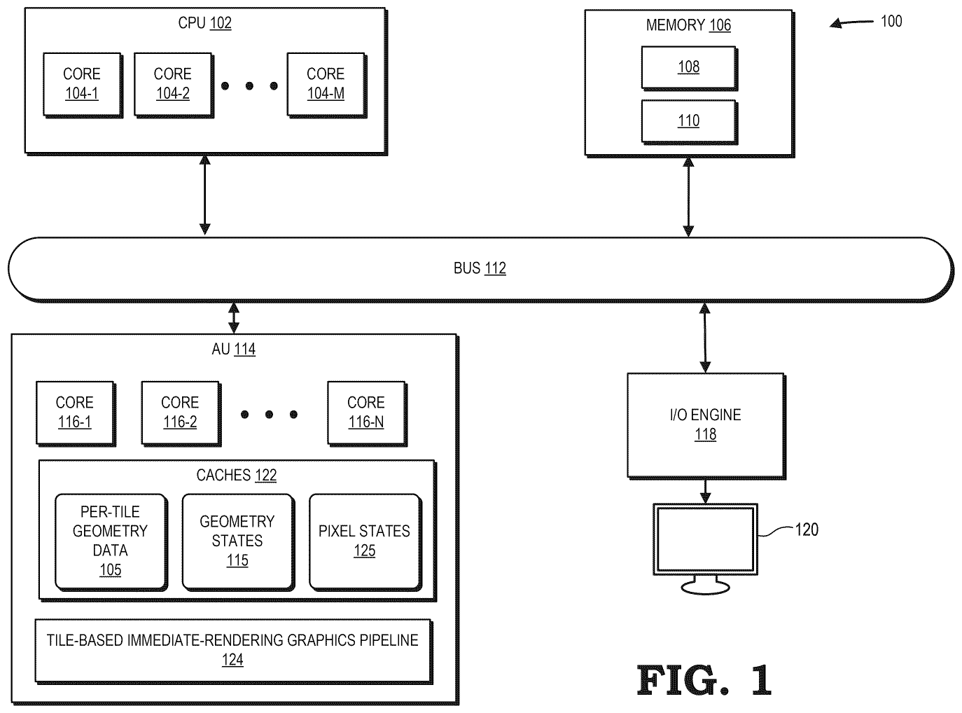

FIG. 1 is a block diagram of a processing system 100 configured to implement a tile-based immediate mode renderer graphics pipeline, according to some implementations. The processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 112 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at acceleration unit (AU) 114. AU 114 includes, for example, vector processors, coprocessors, graphics processing units (GPUs), non-scalar processors, highly parallel processors, other multithreaded processing units, scalar processors, serial processors, programmable logic devices (e.g., field-programmable gate arrays) or any combination thereof. In embodiments, AU 114 renders scenes within a screen space (e.g., the space in which a scene is displayed) according to one or more applications 108 for presentation on a display 120. For example, AU 114 renders graphics objects (e.g., sets of primitives) of a scene in a screen space (e.g., display space) to be displayed to produce values of pixels that are provided to the display 120, which uses the pixel values to display a scene that represents the rendered graphics objects. To render these graphics objects, AU 114 implements a plurality of processor cores 116-1 to 116-N that execute instructions concurrently or in parallel. For example, AU 114 executes instructions from one or more graphics pipelines (e.g., tile-base immediate mode renderer graphics pipeline 124) using a plurality of processor cores 116 to render one or more graphics objects. A graphics pipeline, for example, includes one or more steps, stages, or instructions to be performed by AU 114 in order to render one or more graphics objects for a scene. As an example, a graphics pipeline includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores 116 of AU 114 in order to render one or more graphics objects for a scene.

In embodiments, one or more processor cores 116 of AU 114 each operate as a compute unit configured to perform one or more operations for one or more instructions received by AU 114. These compute units each include one or more single instruction, multiple data (SIMD) units that perform the same operation on different data sets to produce one or more results. For example, AU 114 includes one or more processor cores 116 each functioning as a compute unit that includes one or more SIMD units to perform operations for one or more instructions from a graphics pipeline (e.g. tile-based immediate mode renderer graphics pipeline 124). To facilitate one or compute units performing operations for instructions from a graphics pipeline, AU 114 includes one or more command processors (not shown for clarity). Such command processors, for example, include circuitry configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents AU 114 as having three processor cores (116-1, 116-2, 116-N) representing an N number of cores, the number of processor cores 116 implemented in the AU 114 is a matter of design choice. As such, in other implementations, AU 114 can include any number of processor cores 116.

According to embodiments, one or more processor cores 116 of AU 114 each operating as one or more compute units are configured to store results (e.g., data resulting from the performance of one or more instructions, operations, or both) in one or more caches 122, memory 106, or both. Such caches 122, for example, include one or more caches 122 included in or otherwise connected to processor cores 116. As an example, in embodiments, caches 122 includes one or more caches shared between one or more processor cores 116 (e.g., shared caches), one or more caches private to (e.g., only accessibly by) a corresponding processor core 116 (e.g., private caches), or both. For example, according to some embodiments, caches 122 includes a cache hierarchy including one or more private caches, one or more shared caches, or both.

In embodiments, AU 114 is configured to render one or more graphics objects based on tile-based immediate mode renderer graphics pipeline 124. Tile-based immediate mode renderer graphics pipeline 124, for example, includes an immediate mode renderer in which an application 108 issues a command stream including data describing all the graphics objects (e.g., primitives) in a scene to be rendered for each frame to be rendered. For example, in embodiments, a command stream from an application 108 includes data indicating the position of vertices of one or more primitives to be rendered, one or more commands (e.g., draw commands, shader commands), one or more geometry states 115, and one or more pixel states 125. Such geometry states 115, for example, include data (e.g. parameters) to initialize and dictate the tile-based immediate mode renderer graphics pipeline 124, geometry stages of the tile-based immediate mode renderer graphics pipeline 124, or both. As an example, one or more first geometry states 115 indicate parameters, processes, and data used in initializing the tile-based immediate mode renderer graphics pipeline 124, and one or more second geometry states indicate parameters, processes, and data used in a geometry stage of tile-based immediate mode renderer graphics pipeline 124. Additionally, such pixel states 125 include data (e.g., parameters) to initialize and dictate tile draw stages and tile lighting stages of the tile-based immediate mode renderer graphics pipeline 124. For example, one or more first pixel states 125 indicate parameters, processes, and data used in the tile draw stages of the tile-based immediate mode renderer graphics pipeline 124, and one or more second pixel states 125 indicate parameters, processes, and data used in the tile lighting stages of the tile-based immediate mode renderer graphics pipeline 124. In embodiments, AU 114 is configured to store the geometry states 115 and pixel states 125 indicated in a command stream in one or more caches 122, memory 106, or both. Further, such geometry stages, tile draw stages, and tile lighting stages of tile-based immediate mode renderer graphics pipeline 124 each includes respective sets of commands (e.g., draw commands), geometry states, and pixel states that use the same resources (e.g., same primitive data).

According to embodiments, the tile-based immediate mode renderer graphics pipeline 124 includes partitioning a frame to be rendered into two or more tiles and then rendering the graphics objects of the scene tile by tile. For example, based on one or more first geometry states 115 in a received command stream, AU 114 first partitions a frame to be rendered into two or more tiles (e.g., coarse tiles). Each tile, for example, includes a first number of pixels of the frame in a first direction (e.g., horizontal direction) and a second number of pixels of the frame in a second direction (e.g., vertical direction) perpendicular to the first direction indicated by the one or more first geometry states 115. According to some embodiments, a tile includes the same number of pixels in the first and second directions while in other embodiments the tile includes a different number of pixels in the first and second directions. After partitioning the frame to be rendered into two or more tiles, AU 114 then allocates a number of queues formed from at least a portion of caches 122, memory 106, or both to each tile of the frame such that each tile has a corresponding per-tile queue. As an example, AU 114 divides and allocates one or more per-shader engine queues formed from portions of caches 122 such that each tile of the frame is allocated a per-tile queue. Each per-tile queue, for example, includes one or more queues formed from at least a portion of caches 122, memory 106, or both. After AU 114 has allocated a per-tile queue to each tile of the frame, AU 114 begins a geometry stage of tile-based immediate mode renderer graphics pipeline 124 based on one or more second geometry states 115 of the command stream.

Such a geometry stage, for example, includes a visibility pass in which AU 114 determines which primitives (e.g., graphics objects) are to be rendered for each tile of the frame. For example, based on data indicating vertices of one or more primitives to be rendered in the command stream, AU 114 assembles (e.g., performs an assembly stage) and shades (e.g., performs one or more shaders) the one or more of the indicated primitives. As an example, AU 114 first assembles one or more primitives indicated in the command stream. For each assembled primitive, AU 114 then determines which tiles of the frame the primitive at least partially covers. Based on AU 114 determining that an assembled primitive is at least partially visible in a tile, AU 114 provides geometry data indicating vertex data, shading data, positioning data, or any combination thereof of the primitive to the per-tile queue associated with the tile. According to some embodiments, AU 114 continues to perform the visibility pass until a certain command (e.g., tile flush command) is received from in the command stream, one or more per-tile queues are at a predetermined capacity threshold (e.g., store a predetermined amount of data), or both. After a certain command (e.g., tile flush command) is received from in the command stream, one or more per-tile queues are at a predetermined capacity threshold (e.g., store a predetermined amount of data), or both, AU 114 then renders the group (e.g., batch) of primitives represented by the geometry data stored in the per-tile queues associated with the tiles. The per-tile geometry data of primitives of the batch of primitives at least partially visible in the tiles is represented in FIG. 1 as per-tile geometry data 105.

To render the primitives in the batch of primitives, AU 114 begins a first tile draw stage for a first tile of the frame based on one or more first pixel states 125 indicated in the command stream. As an example, concurrently with continuing the geometry stage, AU 114 begins a first tile draw stage for the first tile based on one or more first pixel states 125. To perform such a tile draw stage, AU 114 is configured to first render the primitives of the batch of primitives at least partially visible in the first tile to one or more PPC buffers formed from at least a portion of caches 122, memory 106, or both. To this end, AU 114 is configured to render the primitives of the batch of primitives at least partially visible in the first tile based on the per-tile geometry data 105 stored in the per-tile queue associated with the first tile. As an example, AU 114 first consumes the per-tile queue associated with the first tile of the per-tile geometry data 105 representing the primitives of the batch of primitives at least partially visible in the first tile. Based on one or more first pixel states 125, AU 114 then assembles, rasterizes, and shades the primitives using the per-tile geometry data 105 to produce per-tile pixel attribute data that is stored in the PPC buffers and per-tile pixel depth data that is stored in a depth buffer (e.g., Z-buffer) formed from at least a portion of caches 122, memory 106, or both. Such per-tile pixel attribute data represents the attributes (e.g., color, position) of the pixels forming the primitives of the patch of primitives at least partially visible in the tile and such per-tile pixel depth data represents the depth of the pixels forming the primitives of the batch of primitives at least partially visible in the tile.

According to embodiments, the tile draw stage further includes AU 114 performing one or more depth culling techniques based on the per-tile pixel depth data in the Z-buffer and one or more first pixel states 125. For example, for each pixel forming a primitive of the batch of primitives at least partially visible in a tile, AU 114 compares the depth value of the pixel to one or more pre-determined threshold values. Based on the comparison of the depth value of the pixel to the predetermined threshold values, AU 114 then culls the pixel from the Z-buffer, PPC buffers, or both by, for example, not storing the pixel attribute data or pixel depth data in the PPC buffers or Z-buffer, respectively. As an example, based on a comparison of the depth value of a pixel to the predetermined threshold values indicating that the pixel is at least partially occluded (e.g., at least a portion of the pixel is not visible in the scene), AU 114 then culls the pixel.

After completing a tile draw stage for a first tile, AU 114 performs a tile lighting stage for the first tile. During such a tile lighting stage, AU 114 performs one or more pixel-shading operations as indicated in one or more second pixel states 125 so as to determine lighting values (e.g., intensity values) that represent the direct and indirect lighting for each pixel forming primitives of the batch of primitives at least partially visible in the tile using the per-tile pixel attribute data in the PPC buffers. AU 114 then stores pixel values representing the color and lighting (e.g., intensity) of each pixel forming primitives at least partially visible in the tile in a frame buffer formed from at least a portion of caches 122, memory 106, or both. In some embodiments, once AU 114 has determined the lighting values for each pixel forming primitives at least partially visible in the tile, AU 114 discards the per-tile pixel attribute data stored in the PPC buffers associated with the tile. For example, based on one or more commands from an application 108, AU 114 discards the per-tile pixel attribute data stored in the PPC buffers associated with the tile after performing the commands included in a tile lighting stage for the tile. That is to say, AU 114 removes the per-tile pixel attribute data associated with the tile from the PPC buffers. After performing the tile draw stage, tile lighting stage, or both for the first tile, AU 114 performs a tile draw stage and tile render stage for each other tile of the frame so as to render the primitives in the batch of primitives. After rendering the primitives in the batch of primitives, AU 114 renders a second batch of primitives based on geometry data determined during the geometry stage by performing a tile draw stage and tile lighting stage for each tile of the frame. The AU 114 continues in this way until all the primitives in the frame are rendered.

In this way, AU 114 is configured to implement a tile-based immediate mode renderer graphics pipeline 124. Because tile-based immediate mode renderer graphics pipeline 124 has AU 114 rendering primitives based on a single command stream from an application 108, processing system 100 is not required to manage in-memory state objects to allow access to stored states by AU 114, reducing the complexity and resources required to render the primitives. Additionally, due to tile-based immediate mode renderer graphics pipeline 124 requiring AU 114 to determine pixel light values from the per-tile pixel attribute data in the PPC buffers, the assembly and shading of primitives done during the tile draw stages are not repeated during the tile lighting stages, helping to reduce the processing resources and processing time needed to render the primitives. Further, because tile-based immediate mode renderer graphics pipeline 124 includes rendering primitives tile by tile rather than for the entire frame at once, the processing resources needed at any one time are reduced, helping to decrease the power consumption and improve the processing efficiency of processing system 100.

According to some embodiments, after AU 114 has completed a tile draw stage for a first tile, AU 114 releases the per-tile pixel attribute data in the PPC buffers and performs a tile lighting stage using the released per-tile pixel attribute data. For example, based on an application 108 providing one or more commands to release the per-tile pixel attribute data (e.g., at a frame buffer level), AU 114 releases the per-tile pixel attribute data after completing the tile draw stage for the first tile and performs a tile lighting stage for the first tile. For example, AU 114 flushes one or more PPC buffers so as to release the per-tile pixel attribute data. Further, in some embodiments, while AU 114 releases per-tile pixel attribute data in the PPC buffers to perform a tile lighting stage for a first tile, AU 114 is configured to perform a tile draw stage for a second tile of the frame, a tile lighting stage for a second tile of the frame, or both. As an example, while the per-tile pixel attribute data in the PPC buffers is released to perform a tile lighting stage for a first tile, AU 114 performs a tile draw stage for a second tile, stores the per-tile pixel attribute data of the primitives in the second tile in the PPC buffers, and releases the per-tile pixel attribute data of the primitives in the second tile in the PPC buffers so as to perform a lighting stage for the second tile. Further, as an example, as AU 114 releases the per-tile pixel attribute data of the primitives in the second tile in the PPC buffers, AU 114 performs the lighting stage for the first tile and a draw stage for a third tile. Due to AU 114 performing such stages (e.g., groups of commands) while per-tile pixel attribute data is released from the PPC buffers, AU 114 is not required to wait for the per-tile pixel attribute data to release before starting a next stage of the tile-based immediate mode renderer graphics pipeline 124, helping reduce pauses between the stages and helping to decrease the time needed to render the primitives. A person of ordinary skill in the art will appreciate that the release and acquisition of such per-tile pixel attribute data is based on commands issued from one or more applications 108 and, as such, represents an example implementation of tile-based immediate mode renderer graphics pipeline 124.

In embodiments, the processing system 100 also includes a central processing unit (CPU) 102 that is connected to the bus 112 and therefore communicates with the AU 114 and the memory 106 via the bus 112. The CPU 102 implements a plurality of processor cores 104-1 to 104-N that execute instructions concurrently or in parallel. In implementations, one or more of the processor cores 104 operate as SIMD units that perform the same operation on different data sets. For example, one or more processor cores 104 operate as SIMD units each having two or more lanes each configured to perform an operation (e.g., spatial test) of a wave. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. In some implementations, the CPU 102 and AU 114 have an equal number of processor cores 104, 116 while in other implementations, the CPU 102 and AU 114 have a different number of processor cores 104, 116. The processor cores 104 execute instructions such as program code 110 for one or more applications 108 stored in the memory 106 and the CPU 102 stores information in the memory 106 such as the results of the executed instructions. The CPU 102 is also able to initiate graphics processing by issuing a command stream from one or more applications 108 to AU 114.

Processing system 100 also includes an input/output (I/O) engine 118 that includes hardware and software to handle input or output operations associated with the display 120, as well as other elements of the processing system 100 such as keyboards, mice, printers, external disks, and the like. The I/O engine 118 is coupled to the bus 112 so that the I/O engine 118 communicates with the memory 106, the AU 114, or the CPU 102.

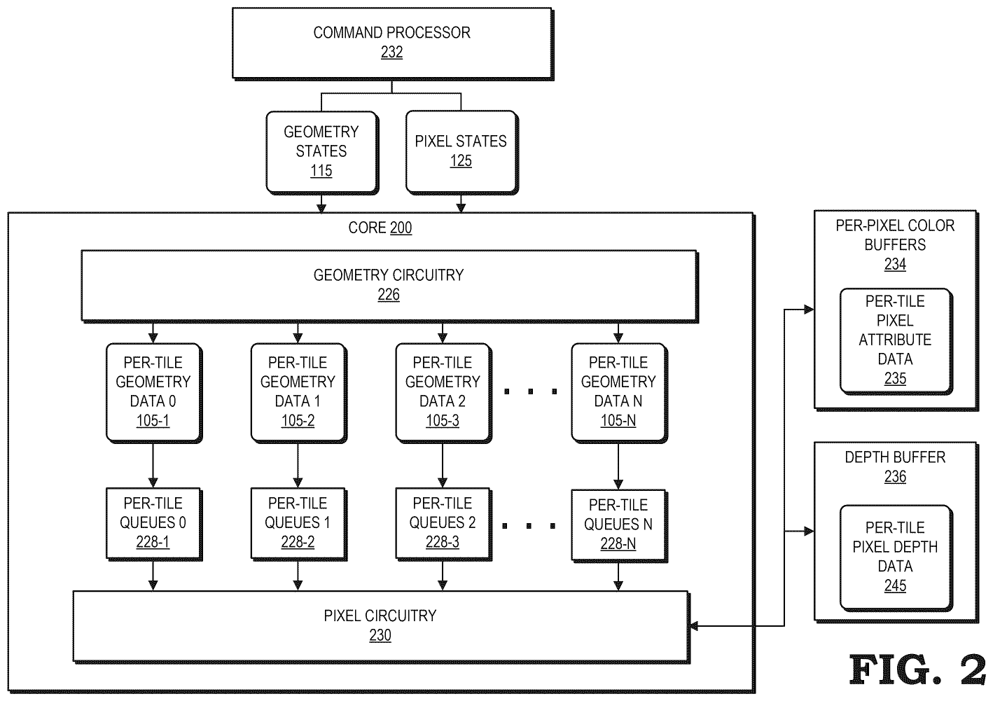

Referring now to FIG. 2, an example processor core 200 configured to implement at least a portion of a tile-based immediate mode renderer graphics pipeline is presented, in accordance with embodiments. In some embodiments, example processor core 200 is implemented within AU 114 as a processor core 116. According to embodiments, example processor core 200 is configured to implement at least a portion of tile-based immediate mode renderer graphics pipeline 124 by executing one or more instructions, operations, or both associated with tile-based immediate mode renderer graphics pipeline 124. To this end, example processor core 200 is connected to command processor 232. Command processor 232, for example, includes circuitry configured to receive a command stream from an application 108. Such a command stream, for example, includes one or more geometry states 115, pixel states 125, and data indicating one or more primitives to be rendered in a scene of a frame. Command processor 232 then provides data indicating the geometry states 115, pixel states 125, and primitives to be rendered (e.g., vertex data) to example processor core 200. Such geometry states 115, for example, include data (e.g. parameters) to initialize and dictate tile-based immediate rendering for the tile-based immediate mode renderer graphics pipeline 124, geometry stages of the tile-based immediate mode renderer graphics pipeline 124, or both. Additionally, such pixel states 125 include data (e.g., parameters) to initialize and dictate tile draw stages and tile lighting stages of the tile-based immediate mode renderer graphics pipeline 124.

Based on one or more first geometry states 115 provided from command processor 232, example processor core 200 initializes tile-based immediate mode renderer graphics pipeline 124. To this end, example processor core 200 first partitions the frame to be rendered into a number of tiles indicated by one or more first geometry states 115. Each tile, for example, includes a number of pixels in a first direction and a number of pixels in a second direction as indicated by one or more first geometry states 115. After partitioning the frame into tiles, example processor core 200 then allocates a per-tile queue 228 to each tile of the frame as indicated by the one or more first geometry states 115. For example, AU 114 allocates a first per-tile queue 0 228-1 to a first tile, a second per-tile queue 1 228-2 to a second tile, a third per-tile queue 2 228-3 to a third tile, and an Nth per-tile queue N 228-N to an Nth tile. Such per-tile queues 228 are each formed from at least a portion of caches 122, memory 106, or both and include one or more queues, for example, first in, first out (FIFO) queues. Though the example embodiment presented in FIG. 2 shows an example processor core 200 with four per-tile queues 228 representing an N number of per-tile queues 228 that support an N number of tiles of a frame, in other embodiments, example processor core 200 can include any number of per-tile queues 228 supporting any number of tiles of a frame. Further, in some embodiments, each per-tile queue 228 is formed from one or more per-shader engine queues of example processor for 200.

Based on one or more second geometry states 115 of the command stream, example processor core 200 then performs a geometry stage (e.g., visibility pass) to determine which primitives to be rendered for the frame are at least partially visible in each tile of the frame. To this end, example processor core 200 includes or is otherwise connected to a geometry circuitry 226 configured to implement one or more primitive assemblers, shaders (e.g., geometry shaders), or both so as to assemble and shade one or more primitives based on one or more second geometry states 115. As an example, based on one or more second geometry states 115 and data indicating the primitives to be rendered for the frame, geometry circuitry 226 assembles and shades one or more of the indicated primitives. Once geometry circuitry 226 has assembled and shaded the indicated primitives, geometry circuitry 226 then, for each assembled primitive, determines which tile the primitive is at least partially visible in. Based on an assembled primitive being at least partially visible in a tile, geometry circuitry 226 provides geometry data representing the vertex data, shading data, positioning data, or any combination of the primitive to the per-tile queue 228 allocated to the tile. In embodiments, geometry circuitry 226 is configured to perform the visibility pass until a certain command (e.g., tile flush command) is received from in the command stream, one or more per-tile queues 228 are at a predetermined capacity threshold (e.g., store a predetermined amount of data), or both. Once a certain command (e.g., tile flush command) is received from in the command stream, one or more per-tile queues 228 are at a predetermined capacity threshold (e.g., store a predetermined amount of data), or both, geometry circuitry 226 forms a batch of primitives to be rendered represented by the geometry data stored in the per-tile queues 228.

After geometry circuitry 226 has stored the geometry data representing each primitive of a batch of primitives at least partially visible in a tile to a corresponding per-tile queue 228, such stored data is represented in FIG. 2 as per-tile geometry data 105. Such per-tile geometry data (105-1, 105-2, 105-3, 105-N) each represents the vertex data, shading data, positioning data, or any combination of primitives in a batch of primitives at least partially visible within a corresponding tile. According to embodiments, once geometry circuitry 226 has stored the per-tile geometry data 105 for the batch of primitives in each per-tile queue 228, example processor core 200 is configured to perform a tile draw stage for a first tile based on one or more first pixel states 125. As an example, currently with geometry circuitry 226 completing a remainder of the geometry stage, example processor core 200 is configured to perform a tile draw stage for the first tile based on one or more first pixel states 125. To this end, processor core 116 includes pixel circuitry 230 configured to implement one or more assemblers, shaders (e.g., fragment shaders), or both based on corresponding pixel states 125.

As an example, to perform a tile draw stage of tile-based immediate mode renderer graphics pipeline 124 for a first tile, pixel circuitry 230 is configured to first consume the per-tile queue 228 (e.g., per-tile queue 0 228-1) associated with the first tile so as to receive the per-tile geometry data 105 (e.g., per-tile geometry data 0 105-1) associated with the first tile. After obtaining the per-tile geometry data 105 associated with the first tile, pixel circuitry 230 then renders the primitives indicated in the per-tile geometry data 105 as a batch (e.g., coarse batch) to one or more PPC buffers 234 based on one or more first pixel states 125. That is to say, AU 114 assembles, rasterizes, and shades the primitives indicated in the per-tile geometry data 105 based on one or more first pixel states 125 to produce per-tile pixel attribute data 235 that is stored in the PPC buffers 234. Further, based on assembling, rasterizing, and shading these primitives based on per-tile geometry data 105, pixel circuitry 230 produces per-tile pixel depth data 245 that is stored in a Z-buffer 236. The PPC buffers 234 and Z-buffer 236, for example, each one or more buffers formed from at least corresponding portions of caches 122, memory 106, or both. As an example, PPC buffers 234 include one or more buffers configured to store data indicating the color and position of each pixel of a frame and Z-buffer 236 includes one or more buffers configured to store data indicating the depth values of each pixel of the frame.

In embodiments, the per-tile pixel attribute data 235 stored in the PPC buffers 234 after performing a tile draw stage for the first tile represents, for example, the attributes (e.g., color, position) of the pixels forming the primitives of the batch of primitives at least partially visible in the first tile and the per-tile pixel depth data 245 stored in the Z-buffer 236 represents the depth of the pixels forming the primitives of the batch of primitives at least partially visible in the first tile. According to embodiments, a tile draw stage further includes pixel circuitry 230 performing one or more depth culling techniques on the per-tile depth data 245 as indicated by the first pixel state 125. As an example, for each pixel forming a primitive at least partially visible in a tile, AU 114 compares the depth value of the pixel indicated in the per-tile pixel depth data 245 to one or more pre-determined threshold values indicated in one or more first pixel states 125. Based on the comparison of the depth value of the pixel to the predetermined threshold values, pixel circuitry 230 culls the pixel from the Z-buffer 236, PPC buffers 234, or both by, for example, not providing the per-tile pixel attribute data 235 or per-tile pixel depth data 245 associated with the pixel to the PPC buffers 234 or Z-buffer 236, respectively. As an example, based on a comparison of the depth value of a pixel as indicated by per-tile pixel depth data 245 to the predetermined threshold values indicating that the pixel is at least partially occluded (e.g., at least a portion of the pixel is not visible in the scene), pixel circuitry 230 then culls the pixel from the Z-buffer 236, PPC buffers 234, or both.

After pixel circuitry 230 has completed the tile draw phase for the first tile and based on one or more second pixel states 125, pixel circuitry 230 performs a lighting stage of the tile-based immediate mode renderer graphics pipeline 124 for the first tile. For example, as indicated by the one or more second pixel states 125, pixel circuitry 230 performs one or more pixel-shading operations using the per-tile pixel attribute data 235 associated with the first tile so as to determine lighting values (e.g., intensity values) that represent the direct and indirect lighting for each pixel forming primitives at least partially visible in the first tile. Pixel circuitry 230 then stores the pixel values representing the color and lighting (e.g., intensity) of each pixel forming primitives at least partially visible in the tile in a frame buffer (not shown for clarity) formed from at least a portion of caches 122, memory 106, or both.

According to some embodiments, based on one or more commands from an application 108, pixel circuitry 230 is configured to release the per-tile pixel attribute data 235 associated with the first tile from the PPC buffers 234 to perform a tile lighting stage for the first tile. To this end, while pixel circuitry 230 releases the per-tile pixel attribute data 235 associated with the first tile from the PPC buffers 234, AU 114 is configured to perform a tile draw stage for a second tile of the frame, a tile lighting stage for a second tile of the frame, or both. As an example, while the per-tile pixel attribute data 235 associated with the first tile is released and based on one or more corresponding pixel states 125, pixel circuitry 230 performs a tile draw stage for a second tile, stores the per-tile pixel attribute data 235 of the second tile in the PPC buffers 234, and releases the per-tile pixel attribute data 235 of the second tile in the PPC buffers 234 so as to perform a lighting stage for the second tile. Further, as an example, as pixel circuitry 230 releases the per-tile pixel attribute data 235 of the second tile in the PPC buffers 234 and based on corresponding pixel states 125, pixel circuitry 230 performs the lighting stage for the first tile and a draw stage for a third tile.

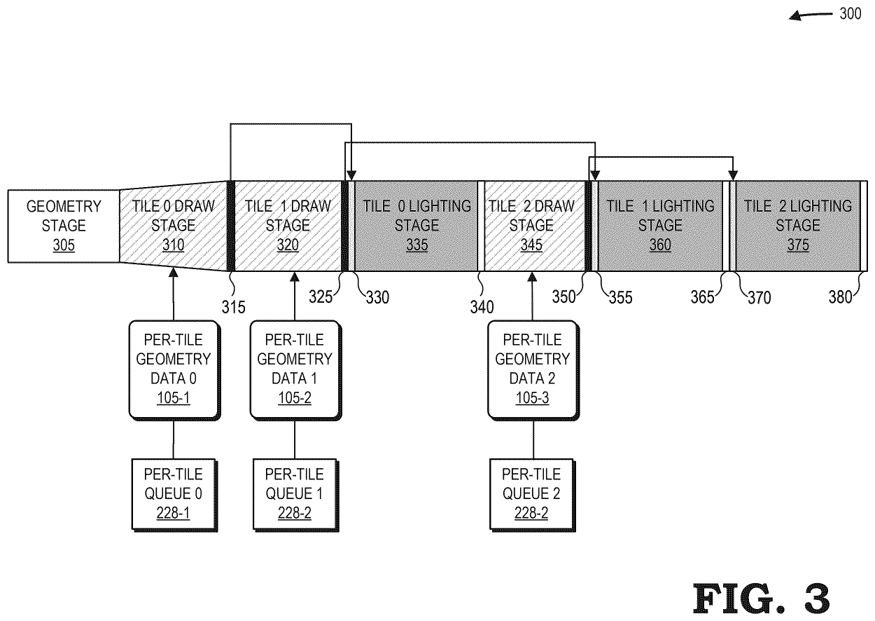

Referring now to FIG. 3, an example tile-based immediate mode renderer graphics pipeline 300 is presented, in accordance with embodiments. According to embodiments, example tile-based immediate mode renderer graphics pipeline 300 is implemented by AU 114 based on one or more commands from an application 108. For example, in embodiments, after tile-based immediate rendering is initialized, example tile-based immediate mode renderer graphics pipeline 300 first includes AU 114 performing a geometry stage 305 based on one or more first geometry states 115. During the geometry stage 305, AU 114 is configured to determine which primitives of a batch of primitives to be rendered for a frame are at least partially visible in each tile of the frame. To this end, AU 114 assembles and shades one or more primitives to be rendered in the frame based on one or more first geometry states 115. For each assembled primitive, AU 114 then determines in which tiles the assembled primitive is at least partially visible (e.g., present). In response to AU 114 determining that an assembled primitive is at least partially visible in a tile, AU 114 provides geometry data (e.g., per-tile geometry data 105) indicating vertex data, shading data, positioning data, or any combination of the primitive to the per-tile queue 228 allocated to the tile.

According to some embodiments, during the geometry stage 305, AU 114 is configured to assemble primitives and determine which tiles the assembled primitives are at least partially visible in until a certain command (e.g., tile flush command) is received in the command stream, one or more per-tile queues 228 are at a predetermined capacity threshold (e.g., store a predetermined amount of data), or both. After the certain command is received in the command stream, one or more per-tile queues 228 are at a predetermined capacity threshold, or both, AU 114 forms a batch of primitives to be rendered that are represented by the per-tile geometry data 105 stored in the per-tile queues 228. That is to say, AU 114 is configured to form a batch of primitives to be rendered based on a certain command being received in the command stream, one or more per-tile queues 228 being at a predetermined capacity, or both. As an example, based on a per-tile queue 228 becoming full, AU 114 is configured to render a batch of primitives (e.g., the primitives represented by the per-tile geometry data in the per-tile queues 228) by performing a tile draw stage and tile lighting stage for each tile of the frame. As another example, after initiating a visibility pass and based on the command stream received by AU 114 indicating a flush tile command, AU 114 is configured to render a batch of primitives by performing a tile draw stage and tile lighting stage for each tile of the frame.

To render primitives in a first batch of primitives, AU 114 is configured to begin a tile 0 draw stage 310 based on one or more first pixel states 125. For example, concurrently with completing the remainder of geometry stage 305, AU 114 begins a tile 0 draw stage 310. During the tile 0 draw stage 310, AU 114 renders the primitives of the batch of primitives at least partially visible in the first frame into the PPC buffers 234 based on the per-tile geometry data 105 stored in the per-tile queue 228 associated with the first tile. For example, referring to the embodiment presented in FIG. 3, AU 114 renders the primitives of the batch of primitives at least partially visible in the first frame based on per-tile geometry data 0 105-1 from per-tile queue 0 228-1. In embodiments, during the tile 0 draw stage 310, AU 114 first assembles, rasterizes, and shades the primitives indicated in per-tile geometry data 0 105-1 based on one or more first pixel states 125 so as to produce per-tile pixel attribute data 235 that is stored in one or more PPC buffers 234 and per-tile pixel depth data 245 that is stored in a Z-buffer 236. According to some embodiments, tile 0 draw stage 310 includes AU 114 performing a scissor operation based on the size of the tile. For example, based on one or more first pixel states, AU 114 discards per-tile pixel attribute data 235 and per-tile pixel depth data 245 associated with any pixels outside of a box based on the size and position of the tile (e.g., a box having the same size and position as the tile). Additionally, in some embodiments, tile 0 draw stage 310 includes AU 114 performing one or more depth culling techniques based on the determined per-tile pixel depth data 245. For example, for each pixel forming a primitive at least partially visible in a tile and based on one or more first pixel states 125, AU 114 compares the depth value of the pixel indicated in the per-tile pixel depth data 245 to one or more pre-determined threshold values. Based the comparison of the depth value of a pixel to the predetermined threshold values indicating that the pixel is at least partially occluded (e.g., at least a portion of the pixel is not visible in the scene), AU 114 then culls the pixel such that the per-tile pixel attribute data 235 and per-tile pixel depth data 245 associated with the pixel are not stored in the PPC buffers 234 and Z-buffer 236, respectively.

After AU 114 has performed tile 0 draw stage 310, in some embodiments, example tile-based immediate mode renderer graphics pipeline 300 includes AU 114 performing a release command 315 based on one or more commands indicated in the command stream. During the release command 315, AU 114 releases the per-tile pixel attribute data 235 associated with the first tile in the PPC buffers 234 such that AU 114 is enabled to perform a lighting stage (e.g., tile 0 lighting stage 335) for the first tile. For example, AU 114 flushes one or more PPC buffers 234 so as to release the per-tile pixel attribute data 235 associated with the first tile. Concurrently with AU 114 performing the release command 315, example tile-based immediate mode renderer graphics pipeline 300 includes AU 114 performing tile 1 draw stage 320 based on the one or more first pixel states. During the tile 1 draw stage 320, AU 114 renders the primitives of the batch of primitives at least partially visible in a second tile of the frame into the PPC buffers 234 based on the per-tile geometry data 105 stored in the per-tile queue 228 associated with the second tile. As an example, referring to the embodiment presented in FIG. 3, AU 114 renders the primitives at least partially visible in the second tile based on per-tile geometry data 1 105-2 from per-tile queue 1 228-2. According to embodiments, during the tile 1 draw stage 320, AU 114 renders the primitives indicated in per-tile geometry data 1 105-2 so as to produce per-tile pixel attribute data 235 associated with the second tile that is stored in one or more PPC buffers 234 and per-tile pixel depth data 245 associated with the second tile that is stored in a Z-buffer 236. In some embodiments, tile 1 draw stage 320 also includes AU 114 performing one or more scissor operations based on the size of the tile, depth-culling operations, or both based on one or more first pixel states 125. Once AU 114 has performed tile 1 draw stage 320, example tile-based immediate mode renderer graphics pipeline 300 includes AU 114 performing a release command 325 based on one or more commands in the command stream (e.g., based on one or more commands from an application 108). During the release command 325, AU 114 releases the per-tile pixel attribute data 235 associated with the second tile in the PPC buffers 234 such that AU 114 is enabled to perform a lighting stage (e.g., tile 1 lighting stage 360) for the second tile.

After release command 325, example tile-based immediate mode renderer graphics pipeline 300 includes AU 114 performing acquire command 330 based on one or more commands of the command stream. During the acquire command 330, AU 114 acquires the per-tile pixel attribute data 235 associated with the first tile that was released from the PPC buffers 234 (e.g., based on release command 315). In response to AU 114 acquiring the per-tile pixel attribute data 235 associated with the first tile, AU 114 then performs tile 0 lighting stage 335 based on one or more second pixel states 125. During tile 0 lighting stage 335, AU 114 determines lighting values (e.g., intensity values) that represent the direct and indirect lighting for each pixel forming primitives of the batch of primitives at least partially visible in the first tile based on the per-tile pixel attribute data 235 associated with the first tile. For example, based on the per-tile pixel attribute data 235 associated with the first tile, AU 114 performs one or more shading operations (e.g., fragment shading operations), lighting operations, or both according to one or more second pixel states 125 to determine the lighting values for each pixel forming primitives of the batch of primitives at least partially visible in the first tile. AU 114 then stores pixel values representing the color and lighting (e.g., intensity) of each pixel forming primitives of the batch of primitives at least partially visible in the first tile in a frame buffer. Additionally, after AU 114 performs tile 0 lighting stage 335, according to some embodiments, example tile-based immediate mode renderer graphics pipeline 300 includes AU 114 performing discard command 340 based on one or more commands in the command stream. The discard command 340, for example, includes AU 114 discarding the per-tile pixel attribute data 235 associated with the first tile. For example, AU 114 removes the per-tile pixel attribute data 235 associated with the first tile from one or more PPC buffers 234 so as to create free entries in the PPC buffers 234.

After discard command 340, example tile-based immediate mode renderer graphics pipeline 300 includes AU 114 performing tile 2 draw stage 345 based on the one or more first pixel states 125. During the tile 2 draw stage 345, AU 114 renders primitives of the batch of primitives at least partially visible in a third tile of the frame to the PPC buffers 234. For example, AU 114 renders the primitives indicated in per-tile geometry data 2 105-3 so as to produce per-tile pixel attribute data 235 associated with the third tile that is stored in one or more PPC buffers 234 and per-tile pixel depth data 245 associated with the third tile that is stored in a Z-buffer 236. According to some embodiments, tile 2 draw stage 345 also includes AU 114 performing one or more scissor operations based on the size of the tile, depth-culling operations, or both as indicated by one or more first pixel states 125. In embodiments, once AU 114 has performed tile 2 draw stage 345, example tile-based immediate mode renderer graphics pipeline 300 includes AU 114 then performing a release command 350 based on one or more commands in the command stream. During the release command 350, AU 114 releases the per-tile pixel attribute data 235 associated with the third tile in the PPC buffers 234 such that AU 114 is enabled to perform a lighting stage (e.g., tile 2 lighting stage 375) for the third tile.

Within example tile-based immediate mode renderer graphics pipeline 300, after release command 350, AU 114 performs attain command 355 based on one or more commands in the command stream during which AU 114 acquires the per-tile pixel attribute data 235 associated with the second tile that was released from the PPC buffers 234 (e.g., based on release command 325). In response to AU 114 acquiring the per-tile pixel attribute data 235 associated with the second tile, AU 114 then performs tile 1 lighting stage 360 based on the one or more second pixel states 125. To perform tile 1 lighting stage 360, AU 114 performs, based on the released per-tile pixel attribute data 235 associated with the second tile, one or more shading operations (e.g., fragment shading operations), lighting operations, or both as indicated in one or more second pixel states 125 to determine lighting values (e.g., intensity values) that represent the direct and indirect lighting for each pixel forming primitives of the batch of primitives at least partially visible in the second tile. AU 114 then stores pixel values representing the color and lighting (e.g., intensity) of each pixel forming primitives of the batch of primitives at least partially visible in the second tile in the frame buffer. Further, after AU 114 performs tile 1 lighting stage 360, example tile-based immediate mode renderer graphics pipeline 300 includes AU 114 performing discard command 365 based on one or more commands in the command stream during which AU 114 discards the per-tile pixel attribute data 235 associated with the second tile from the PPC buffers 234.

After discard command 365, AU 114 performs attain command 370 based on one or more commands of the command stream during which AU 114 acquires the per-tile pixel attribute data 235 associated with the third tile that was released from the PPC buffers 234 (e.g., based on release command 350). Once AU 114 has acquired the per-tile pixel attribute data 235 associated with the third tile, AU 114 performs tile 2 lighting stage 375 based on the one or more second pixel states 125. To this end, AU 114 performs, based on the released per-tile pixel attribute data 235 associated with the third tile, one or more shading operations (e.g., fragment shading operations), lighting operations, or both to determine lighting values (e.g., intensity values) that represent the direct and indirect lighting for each pixel forming primitives at least partially visible in the third tile. AU 114 then stores pixel values representing the color and lighting (e.g., intensity) of each pixel forming primitives of the batch of primitives at least partially visible in the third tile in the frame buffer. Additionally, after AU 114 performs tile 1 lighting stage 360, example tile-based immediate mode renderer graphics pipeline includes AU 114 performing discard command 380 based on one or more commands in the command stream during which AU 114 discards the per-tile pixel attribute data 235 associated with the third tile from the PPC buffers 234. Though the example tile-based immediate mode renderer graphics pipeline 300 presented in FIG. 3 shows AU 114 as performing a respective tile draw stage (310, 320, 345) and tile lighting stage (335, 360, 375) for three tiles of a frame, in other embodiments, the example tile-based immediate mode renderer graphics pipeline 300 includes AU 114 performing a respective tile draw stage and tile lighting stage for any number of tiles of a frame.

According to embodiments, concurrently with performing one or more tile draw stages (e.g., 310, 320, 345), tile lighting stages (e.g., 335, 360, 375), or both for each tile of the frame to render the primitives in the first batch, AU 114 continues the visibility pass of geometry stage 305 until a certain command (e.g., tile flush command) is received from in the command stream, one or more per-tile queues 228 are at a predetermined capacity threshold (e.g., store a predetermined amount of data), or both, forming a second batch of primitives to be rendered. AU 114 then renders the second batch of primitives by again performing a tile draw stage and tile lighting stage for each tile using the per-tile geometry data 105 in the per-tile queues 228 associated with the second batch of primitives. AU 114 then continues in this way until all the primitives associated with the frame have been rendered.

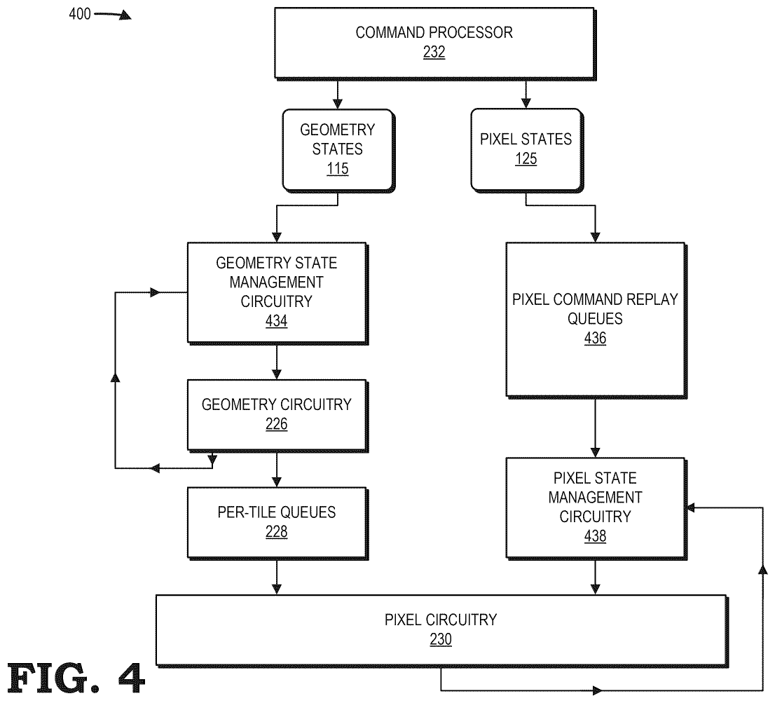

Referring now to FIG. 4, an example operation 400 for managing geometry and pixel states for a tile-based immediate-render graphics pipeline is presented, in accordance with some embodiments. In embodiments, example operation 400 is performed by AU 114 while implementing tile-based immediate mode renderer graphics pipeline 124. According to embodiments, example operation 400 first includes a command processor 232 receiving a command stream from, for example, CPU 102 that indicates one or more geometry states 115 and one or more pixel states 125 (e.g., first pixel states, second pixel states) for a scene to be rendered in a frame. Based on the received command stream, command processor 232 provides data indicating the geometry states 115 to a geometry state management circuitry 434. Such geometry state management circuitry 434, for example, is configured to store data indicating the geometry states 115 in one or more queues. For example, geometry state management circuitry 434 stores data indicating the geometry states 115 in the received command stream in one or more FIFO queues. Geometry state management circuitry 434 then passes the stored data indicating the geometry states 115 to geometry circuitry 226 so as to initiate and perform one or more stages (e.g., groups of commands) of tile-based immediate mode renderer graphics pipeline 124. For example, geometry state management circuitry 434 passes data indicating one or more first geometry states 115 to geometry circuitry 226 so as to induce geometry circuitry 226 to initialize tile-based immediate rendering. As another example, geometry state management circuitry 434 passes data indicating one or more second geometry states 115 to geometry circuitry 226 so as to induce geometry circuitry 226 to perform a geometry stage (e.g., geometry stage 305) that includes a visibility pass. As geometry circuitry 226 performs such a geometry stage, geometry circuitry 226 stores geometry data (e.g. per-tile geometry data 105) for each tile in a corresponding per-tile queue 228 allocated to the tile.

In embodiments, after geometry circuitry 226 has completed one or more tasks (e.g., visibility pass tasks, geometry shading tasks) of a geometry stage (e.g., a geometry stage induced by geometry state management circuitry 434), geometry circuitry 226 indicates to geometry state management circuitry 434 that one or more tasks have been completed. Geometry state management circuitry 434 then issues one or more next geometry states 115 to induce geometry circuitry 226 to perform a next task of the geometry stage. In some embodiments, each processor core 116 of AU 114 includes or is otherwise connected to a respective instance of geometry state management circuitry 434.

Additionally, in embodiments, based on the received command stream, example operation 400 includes command processor 232 provides data indicating the pixel states 125 to a one or more pixel command replay queues 436. Such pixel command replay queues 436, for example, include one or more FIFO queues formed from at least a portion of caches 122, memory 106, or both. According to embodiments, such pixel command replay queues 436 are configured to provide the pixel states 125 stored in the pixel command replay queues 436 in the order in which they were received by the pixel command replay queues 436 to pixel state management circuitry 438. Based on the pixel states 125 received from the pixel command replay queues 436, pixel state management circuitry 438 is configured to induce pixel circuitry 230 to initiate and perform tile draw stages (e.g., tile draw stages 310, 320, 345) and tile lighting stages (e.g., tile lighting stages 335, 360, 375) for the tile-based immediate mode renderer graphics pipeline 124.

As an example, pixel state management circuitry 438 passes one or more first pixel states 125 from pixel command replay queues 436 to pixel circuitry 230 so as to induce pixel circuitry 230 to perform a tile draw stage for a first tile of the frame. Based on the first pixel states 125, pixel circuitry 230 then performs the tile draw stage so as to produce per-tile pixel attribute data 235 for the first tile that is stored in the PPC buffers 234. Once pixel circuitry 220 has completed the tile draw stage, pixel circuitry 220 then sends data to pixel state management circuitry 438 indicating that the tile draw stage has been completed. Pixel state management circuitry 438 then provides corresponding pixel states 125 from the pixel command replay queues 436 to pixel circuitry 220 so as to induce pixel circuitry 220 to perform subsequent stages (e.g., tile lighting states, tile draw stages) for the tile-based immediate mode renderer graphics pipeline 124. Additionally, in embodiments, pixel state management circuitry 438 is configured to compare a pixel state 125 to be issued by pixel state management circuitry 438 to a current pixel state 125 received by pixel circuitry 220. That is to say, configured to compare a pixel state 125 to be issued to a most recently issued pixel state 125. Based on the comparison indicating that the pixel state 125 to be issued is the same as the pixel state 125 that was most recently issued, pixel state management circuitry 438 filters out the pixel state 125 to be issued and does not provide it to pixel circuitry 220. In some embodiments, each processor core 116 of AU 114 includes or is otherwise connected to a respective instance of pixel command replay queues 436, pixel state management circuitry 438, or any combination thereof.

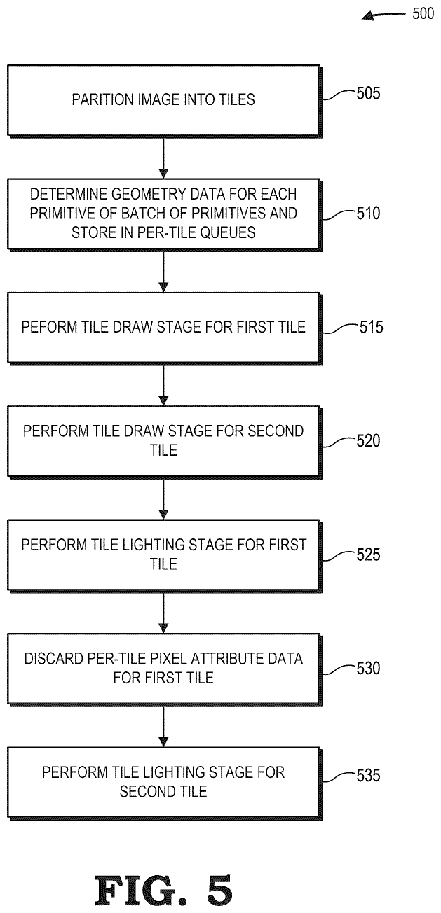

Referring now to FIG. 5, an example method 500 for performing a tile-based immediate mode renderer graphics pipeline is presented, in accordance with embodiments. In embodiments, example method 500 is implemented by at least a portion of AU 114 (e.g. one or more processor cores 116 of AU 114). In embodiments, example method 500 first includes, at block 505, AU 114 receiving a command stream from CPU 102 indicating one or more geometry states 115 and one or more pixel states 125. Based on receiving such a command stream, AU 114 partitions a frame to be rendered into two or more tiles. Each tile, for example, includes a first number of pixels of the frame in a first direction and a second number of pixels of the frame in a second direction. Further, at block 505, AU 114 allocates a corresponding per-tile queue 228 to each tile of the frame. At block 510, example method 500 includes AU 114 determining per-tile geometry data 105 for primitive of a first batch of primitives to be rendered for the frame. To this end, AU 114 performs one or more assembly operations, shading operations (e.g., geometry shading operations), or both based on the geometry states 115 indicated in the command stream to produce one or more assembled primitives. For each assembled primitive, AU 114 then performs a visibility pass to determine in which tiles the assembled primitive is at least partially visible. Based on a primitive being at least partially within a respective tile, AU 114 stores geometry data (e.g., per-tile geometry data 105) indicating vertex data, shading data, positioning data, or any combination associated with the primitive in the tile in a per-tile queue 228 allocated to the tile.

Based on AU 114 determining whether each primitive of a batch of primitives is at least partially visible in each tile of the frame, at block 515, AU 114 begins to render the batch of primitives by performing a tile draw stage (e.g., tile 0 draw stage 310) for a first tile of the frame. To this end, AU 114 renders the primitives of the batch of primitives at least partially visible in the first tile into the PPC buffers 234 based on the per-tile geometry data 105 stored in the per-tile queue 228 associated with the first tile. That is to say, AU 114 assembles, rasterizes, and shades the primitives of the batch of primitives indicated in per-tile geometry data 105 associated with the first tile so as to produce per-tile pixel attribute data 235 associated with the first tile that is stored in one or more PPC buffers 234 and per-tile pixel depth data 245 associated with the first tile that is stored in a Z-buffer 236. In some embodiments, at block 515, the tile draw stage further includes AU 114 performing one or more scissor operations, depth culling operations, or both. Further, at block 515, in some embodiments, after AU 114 has written the per-tile pixel attribute data 235 associated with the first frame that is stored in a PPC buffers 234, AU 114, based on one or more commands from an application 108, releases the per-tile pixel attribute data 235 associated with the first tile from the PPC buffers 234 so as to enable AU 114 to perform a subsequent tile lighting stage for the first tile.

At block 520, AU 114 performs a tile draw stage (e.g., tile 1 draw stage 320) for a second tile of the frame. To this end, AU 114 renders the primitives of the batch of primitives at least partially visible in the second tile into the PPC buffers 234 based on the per-tile geometry data 105 stored in the per-tile queue 228 associated with the second tile. As an example, AU 114 assembles, rasterizes, and shades the primitives indicated in per-tile geometry data 105 associated with the second tile so as to produce per-tile pixel attribute data 235 associated with the second tile that is stored in one or more PPC buffers 234 and per-tile pixel depth data 245 associated with the first frame that is stored in a Z-buffer 236. In some embodiments, at block 520, the tile draw stage further includes AU 114 performing one or more scissor operations, depth culling operations, or both. After AU 114 has written the per-tile pixel attribute data 235 associated with the second tile to the PPC buffers 234, AU 114, based on one or more commands from an application 108, releases the per-tile pixel attribute data 235 associated with the second tile from the PPC buffers 234 so as to enable AU 114 to perform a subsequent tile lighting stage for the second tile.

At block 525, AU 114 is configured to perform a tile lighting stage (e.g., tile 0 lighting stage 335) for the first tile of the frame. During tile lighting stage, at block 525, AU 114 determines lighting values (e.g., intensity values) that represent the direct and indirect lighting for each pixel forming primitives of the batch of primitives at least partially visible in the first tile based on the released per-tile pixel attribute data 235 associated with the first tile. As an example, based on per-tile pixel attribute data 235 associated with the first tile, AU 114 performs one or more shading operations (e.g., fragment shading operations), lighting operations, or both to determine the lighting values for each pixel forming primitives at least partially visible in the first tile. AU 114 then stores pixel values representing the color and lighting (e.g., intensity) of each pixel forming primitives of the batch of primitives at least partially visible in the first tile in a frame buffer. Based on AU 114 completing the tile lighting stage, at block 530, AU 114 then discards the per-tile pixel attribute data 235 associated with the first tile from the PPC buffers 234. After discarding the per-tile pixel attribute data 235 associated with the first tile, at block 535, AU 114 then performs a tile lighting stage (e.g., tile 1 lighting stage 360) for the second tile of the frame. During tile lighting stage at block 535, AU 114 determines lighting values (e.g., intensity values) that represent the direct and indirect lighting for each pixel forming primitives of the batch of primitives at least partially visible in the second tile based on the per-tile pixel attribute data 235 associated with the second tile. AU 114 then stores pixel values representing the color and lighting (e.g., intensity) of each pixel forming primitives at least partially visible in the second tile in a frame buffer.

In some embodiments, the apparatus and techniques described above are implemented in a system including one or more integrated circuit (IC) devices (also referred to as integrated circuit packages or microchips), such as the AU described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design shown herein, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An acceleration unit (AU), comprising:
one or more caches; and
one or more processor cores coupled to the one or more caches and configured to:
partition a frame to be rendered into a plurality of tiles;
for a first tile of the plurality of tiles, write pixel attribute data of primitives at least partially visible in the first tile to the one or more caches; and
based on the pixel attribute data of the primitives at least partially visible in the first tile stored in the one or more caches, determine lighting data for the primitives at least partially visible in the first tile.

2. The AU of claim 1, wherein the one or more processor cores are configured to:
release the pixel attribute data of primitives at least partially visible in the first tile stored in the one or more caches; and
concurrently with releasing pixel attribute data of primitives at least partially visible in the first tile stored in the one or more caches, write pixel attribute data of primitives at least partially visible in a second tile of the plurality of tiles to the one or more caches.

3. The AU of claim 2, wherein the one or more processor cores are configured to:
based on the pixel attribute data of the primitives at least partially visible in the second tile stored in the one or more caches, determine lighting data for the primitives at least partially visible in the second tile.

4. The AU of claim 1, wherein the one or more processor cores are configured to:
based on determining the lighting data for the primitives at least partially visible in the first tile, discard the pixel attribute data of the primitives at least partially visible in the first tile.

5. The AU of claim 1, wherein the one or more processor cores are configured to perform a visibility pass that determines which primitives of a batch of primitives of the frame are at least partially visible in each tile of the plurality of tiles.

6. The AU of claim 5, wherein the visibility pass includes writing, for each tile of the plurality of tiles, geometry data of primitives of the batch of primitives at least partially visible in the tile to a queue allocated to the tile.

7. The AU of claim 5, wherein the one or more processor cores are configured to form the batch of primitives to be rendered based on a queue allocated to a corresponding tile of the plurality of tiles reaching a capacity threshold.

8. A method, comprising:
partitioning a frame to be rendered into a plurality of tiles;
for a first tile of the plurality of tiles, writing pixel attribute data of primitives at least partially visible in the first tile to the one or more caches; and
based on the pixel attribute data of the primitives at least partially visible in the first tile stored in the one or more caches, determining lighting data for the primitives at least partially visible in the first tile.

9. The method of claim 8, further comprising:
releasing the pixel attribute data of the primitives at least partially visible in the first tile stored in the one or more caches; and
concurrently with releasing the pixel attribute data of the primitives at least partially visible in the first tile stored in the one or more caches, writing pixel attribute data of primitives at least partially visible in a second tile of the plurality of tiles to the one or more caches.

10. The method of claim 9, further comprising:
based on the pixel attribute data of the primitives at least partially visible in the second tile stored in the one or more caches, determining lighting data for the primitives at least partially visible in the second tile.

11. The method of claim 8, further comprising:
based on determining the lighting data for the primitives at least partially visible in the first tile, discarding the pixel attribute data of the primitives at least partially visible in the first tile.

12. The method of claim 8, further comprising:
performing a visibility pass that determines which primitives of a batch of primitives are at least partially visible in each tile of the plurality of tiles.

13. The method of claim 12, further comprising:
forming the batch of primitives based on a queue allocated to a corresponding tile of the plurality of tiles reaching a capacity threshold.

14. The method of claim 12, wherein the visibility pass includes writing, for each tile of the plurality of tiles, geometry data of one or more primitives of the batch of primitives at least partially visible in the tile to a queue allocated to the tile.

15. A acceleration unit (AU), comprising:
a plurality of per-tile queues each allocated to a tile of a plurality of tiles of a frame to be rendered; and
one or more processor cores configured to:
for each tile of the plurality of tiles:
write geometry data of one or more primitives of the frame to be rendered at least partially visible in the tile in a per-tile queue of the plurality of per-tile queues allocated to the tile; and
render, to one or more per-pixel color buffers (PPC buffers), pixel attribute data of the one or more primitives at least partially visible in the tile based on the geometry data of the one or more primitives at least partially visible in the tile stored in the per-tile queue allocated to the tile.

16. The AU of claim 15, wherein the one or more processor cores are configured to:
for each tile of the plurality of tiles, based on the pixel attribute data of the one or more primitives at least partially visible in the tile, determine lighting data of the one or more primitives at least partially visible in the tile.

17. The AU of claim 15, wherein the one or more processor cores are configured to:
release, from the PPC buffers, pixel attribute data of one or more primitives at least partially visible in a first tile of the plurality of tiles; and
concurrently with releasing the pixel attribute data of the one or more primitives at least partially visible in a first tile from the PPC buffers, rendering, to the PPC buffers, pixel attribute data of one or more primitives at least partially visible in a second tile of the plurality of tiles.

18. The AU of claim 17, wherein the one or more processor cores are configured to:
determine lighting data for the pixels of the one or more primitives at least partially visible in the first tile of the plurality of tiles based on the pixel attribute data of the one or more primitives at least partially visible in a first tile of the plurality of tiles.

19. The AU of claim 15, wherein the one or more processor cores are configured to:
for each tile of the plurality of tiles, perform a scissor operation on pixels of the one or more primitives at least partially visible in the tile.

20. The AU of claim 15, wherein the one or more processor cores are configured to:
for each tile of the plurality of tiles, perform a depth-culling operating on pixels of the one or more primitives at least partially visible in the tile.
